(19) United States
(12) Patent Application Publication
(10) Pub. No.: US 2011/0287241 A1
(43) Pub. Date: Nov. 24, 2011

(54) Graphene Tapes

(75) Inventors: Sibel Korkut, Princeton, NJ (US); David L. Milius, Princeton, NJ (US); Joseph D. Roy-Mayhew, Princeton, NJ (US); Daniel M. Dabbs, Princeton, NJ (US); Ilhan A. Aksay, Princeton, NJ (US)

(73) Assignees: VORBECK MATERIALS CORP., Jessup, MD (US); THE TRUSTEES OF PRINCETON UNIVERSITY, Princeton, NJ (US)

(21) Appl. No.: 12/949,448

(22) Filed: Nov. 18, 2010

Related U.S. Application Data
(60) Provisional application No. 61/391,670, filed on Oct. 10, 2010.
(60) Provisional application No. 61/262,319, filed on Nov. 18, 2009.

(51) Int. Cl. B32B 5/00; B05D 5/12; C01B 31/00; C01B 31/04; B82Y 99/00; B82Y 40/00

(52) U.S. Cl. 428/219; 423/448; 423/415.1; 427/122; 977/734; 977/932; 977/948; 977/842

(57) ABSTRACT

Graphene tapes made by forming a film comprising graphene sheets and at least one polymeric binder and heating the film to decompose the polymer. The tapes may be used as electrodes.

### REFERENCE TO RELATED APPLICATIONS

The present application claims priority to U.S. Provisional Application No. 61/262,319, filed Nov. 18, 2009, and U.S. Provisional Application No. 61/391,670, filed Oct. 10, 2010, the entire contents of each of which are hereby incorporated by reference.

### FIELD OF THE INVENTION

The present invention relates to graphene tapes, including free-standing tapes, and methods of making graphene tapes.

### BACKGROUND

Due to its exceptional mechanical, electrical, and thermal properties, graphene has been coming under increasing interest for a wide range of applications, including electronic devices and energy storage applications. However, its industrial scale availability is generally as a powder, which form often does not lend itself to many applications. Graphene has been added to polymeric binders and other materials to form composites that be used for many applications, but the presence of the other components in the composites can adversely affect the electrical, chemical, or other desired properties of the material. It would thus be desirable to obtain a free-standing, mechanically stable graphene material containing little to no binder or other additives.

Li, X.; Zhang, G.; Bai, X. “Highly conductive graphene sheets and Langmuir-Blodgett films,” Nature Nanotech. 3, 538-542 (2008) discloses networks of graphene made using Langmuir-Blodgett films. Chen, H.; Muller, M. B.; Gilmore, K. J. et al., “Mechanically strong, electrically conductive, and biocompatible graphene paper”, Adv. Mat., 20, 3557-3561, 2008 and Dikin, D. A.; Stankovich, S.; Zimney, E. J. “Preparation and characterization of graphene oxide paper”, Nature, 448, 457-460 (2007) describe the use of membrane filtration to form graphene and graphite oxide papers.

### SUMMARY OF THE INVENTION

Disclosed and claimed herein are graphene tapes and free-standing graphene tapes. Also disclosed and claimed is a method of forming a graphene tape, comprising the steps of forming a film comprising graphene sheets and at least one polymer binder and heating the film to decompose the binder. Further disclosed and claimed herein is a solar cell comprising at least one graphene tape.

### DETAILED DESCRIPTION OF THE INVENTION

The graphene tapes of the invention are prepared by heating a film comprising graphene sheets and at least one polymer binder.

Graphene sheets may be made using any suitable method. For example, they may be obtained from graphite, graphite oxide, expandable graphite, expanded graphite, etc. They may be obtained by the physical exfoliation of graphite, by for example, peeling off sheets graphene sheets. They may be made from inorganic precursors, such as silicon carbide. They may be made by chemical vapor deposition (such as by reacting a methane and hydrogen on a metal surface). They may be may by the reduction of an alcohol, such ethanol, with a metal (such as an alkali metal like sodium) and the subsequent pyrolysis of the alkoxide product (such a method is reported in Nature Nanotechnology (2009), 4, 30-33). They may be made by the exfoliation of graphite in dispersions or exfoliation of graphite oxide in dispersions and the subsequently reducing the exfoliated graphite oxide. Graphene sheets may be made by the exfoliation of expandable graphite, followed by intercalation, and ultrasonication or other means of separating the intercalated sheets (see, for example, Nature Nanotechnology (2008), 3, 538-542). They may be made by the intercalation of graphite and the subsequent exfoliation of the product in suspension, thermally, etc.

Graphene sheets may be made from graphite oxide (also known as graphitic acid or graphene oxide). Graphite may be treated with oxidizing and/or intercalating agents and exfoliated. Graphite may also be treated with intercalating agents and electrochemically oxidized and exfoliated. Graphene sheets may be formed by ultrasonically exfoliating suspensions of graphite and/or graphite oxide in a liquid (which may contain surfactants and/or intercalants). Exfoliated graphite oxide dispersions or suspensions can be subsequently reduced to graphene sheets. Graphene sheets may also be formed by mechanical treatment (such as grinding or milling) to exfoliate graphite or graphite oxide (which would subsequently be reduced to graphene sheets).

Reduction of graphite oxide to graphene may be by means of chemical reduction and may be carried out in graphite oxide in a solid form, in a dispersion, etc. Examples of useful chemical reducing agents include, but are not limited to, hydrazines (such as hydrazine, N,N-dimethylhydrazine, etc.), sodium borohydride, hydroquinone, isocyanates (such as phenyl isocyanate), hydrogen, hydrogen plasma, etc. A dispersion or suspension of exfoliated graphite oxide in a carrier (such as water, organic solvents, or a mixture of solvents) can be made using any suitable method (such as ultrasonication and/or mechanical grinding or milling) and reduced to graphene sheets.

Graphite oxide may be produced by any method known in the art, such as by a process that involves oxidation of graphite using one or more chemical oxidizing agents and, optionally, intercalating agents such as sulfuric acid. Examples of oxidizing agents include nitric acid, sodium and potassium nitrates, perchlorates, hydrogen peroxide, sodium and potassium permanganates, phosphorus pentoxide, bisulfites, etc. Preferred oxidants include KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite may also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

One example of a method for the preparation of graphene sheets is to oxidize graphite to graphite oxide, which is then thermally exfoliated to form graphene sheets (also known as thermally exfoliated graphite oxide), as described in US 2007/0092432, the disclosure of which is hereby incorporated herein by reference. The thusly formed graphene sheets may display little or no signature corresponding to graphite or graphite oxide in their X-ray diffraction pattern.

The thermal exfoliation may be carried out in a continuous, semi-continuous batch, etc. process.

Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel. Heating may be done using a flash lamp. During heating, the graphite oxide may be contained in an essentially constant location in single batch reaction vessel, or may be transported through one or more vessels during the reaction in a continuous or batch mode. Heating may be done using any suitable means, including the use of furnaces and infrared heaters.

Examples of temperatures at which the thermal exfoliation of graphite oxide may be carried out are at least about 300° C., at least about 400° C., at least about 450° C., at least about 500° C., at least about 600° C., at least about 700° C., at least about 750° C., at least about 800° C., at least about 850° C., at least about 900° C., at least about 950° C., and at least about 1000° C. Preferred ranges include between about 750 about and 3000° C., between about 850 and 2500° C., between about 950 and about 2500° C., and between about 950 and about 1500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature may vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets may be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used may be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature may vary within these ranges.

The heating may be done under a variety of conditions, including in an inert atmosphere (such as argon or nitrogen) or a reducing atmosphere, such as hydrogen (including hydrogen diluted in an inert gas such as argon or nitrogen), or under vacuum. The heating may be done in any appropriate vessel, such as a fused silica or a mineral or ceramic vessel or a metal vessel. The materials being heated including any starting materials and any products or intermediates) may be contained in an essentially constant location in single batch reaction vessel, or may be transported through one or more vessels during the reaction in a continuous or batch reaction. Heating may be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g., or of least about 700 m²/g, or of least about 800 m²/g, or of least about 900 m²/g, or of least about 700 m²/g. The surface area may be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest).

Surface area can be measured using either the nitrogen adsorption/BET method at 77 K or a methylene blue (MB) dye method in liquid solution. The BET method is preferred. The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets may have a bulk density of from about 0.1 to at least about 200 kg/m³. The bulk density includes all values and subvalues therebetween, especially including 0.5, 1, 5, 10, 15, 20, 25, 30, 35, 50, 75, 100, 125, 150, and 175 kg/m³.

The graphene sheets may be functionalized with, for example, oxygen-containing functional groups (including, for example, hydroxyl, carboxyl, and epoxy groups) and typically have an overall carbon to oxygen molar ratio (C/O ratio), as determined by elemental analysis of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 2:1, or at least about 5:1, or at least about 10:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets may contain atomic scale kinks. These kinks may be caused by the presence of lattice defects in, or by chemical functionalization of the two-dimensional hexagonal lattice structure of the graphite basal plane.

The films may be prepared by a solution processing method. Suspensions comprising graphene sheets, a solvent, at least one polymer binder, and optionally at least one surfactant may be applied to a substrate using any suitable process, including a doctor blade method, casting, spin casting, spin coating, dip coating, printing, spray coating, electrospraying, etc. The solvent may then be removed by drying or evaporation, by polymerizing or curing (such as by light, heat, etc.), and/or any other suitable method. The film is heated to decompose the binder (and surfactant, if used) and form the tape. After decomposition, preferably no more than about 60 percent, or no more than about 50 percent, or no more than about 40 percent, or no more than about 25 percent, or no more than about 20 percent, or no more than about 15 percent, or no more than about 10 percent, or no more than about 5 percent of the original binder and surfactant (if present) mass remains in the tapes. The amount of binder (and surfactant if present) remaining can be determined by measuring loss in mass of the tape relative to that of the precursor film.

The graphene sheets may be cross-linked by, for example covalently bound tethers, etc., to each other prior to being combined with the binder (or binder precursors), or they may be held together by covalent bound tethers without the need for an extra binder. They may also be cross-linked after they have been combined, during solvent removal, and/or during heating.

In some embodiments, the graphene sheets may comprise about 5 to about 70 weight percent, or about 5 to about 60 weight percent, or about 5 to about 50 weight percent, or about 10 to about 45 weight percent of the total amount of graphene sheets, binder, and surfactant (if used).

Examples of substrates include glass, including glass that has been surface treated (such as with a silane) to facilitate removal of the films or tapes, silicon, metals (such as for electrode applications), polymers, solid or gel electrolytes, etc. Examples of solvents include water (including water at various pHs), alcohols (such as methanol, ethanol, propanol, etc.), chlorinated solvents (such as methylene chloride, chloroform, carbon tetrachloride, etc.), tetrahydrofuran, dimethylformamide, N-methylpyrrolidone, gamma-butyrolactone, etc.

The suspensions may further comprise surfactants such as poly(ethylene oxide)s, poly(propylene oxide)s, ethylene oxide/propylene oxide copolymers (including block copolymers), gum arabic, poly(vinyl alcohol), ionic surfactants, sulfates (sulfates (such as alkyl sulfates (including ammonium lauryl sulfate, sodium lauryl sulfate (SDS) and alkyl ether sulfates (such as sodium laureth sulfate)), sulfonates, phosphates (including alkyl aryl ether phosphates and alkyl ether phosphates), carboxylates, cationic amines, quaternary ammonium cations, etc.

Examples of polymeric binders include polysiloxanes (such as poly(dimethylsiloxane), dimethylsiloxane/vinylmethylsiloxane copolymers, vinyldimethylsiloxane terminated poly(dimethylsiloxane), etc.), polyethers and glycols such as poly(ethylene oxide)s (also known as poly(ethylene glycol)s, poly(propylene oxide)s (also known as poly(propylene glycol)s, and ethylene oxide/propylene oxide copolymers (including block copolymers), cellulosic resins (such as ethyl cellulose, ethyl hydroxyethyl cellulose, carboxymethyl cellulose, cellulose acetate, cellulose acetate propionates, and cellulose acetate butyrates), and poly(vinyl butyral), polyvinyl alcohol and its derivatives, poly(vinyl acetate), ethylene/vinyl acetate polymers, acrylic polymers and copolymers (such as methyl methacrylate polymers, methacrylate copolymers, polymers derived from one or more acrylates, methacrylates, ethyl acrylates, ethyl methacrylates, butyl acrylates, butyl methacrylates and the like), styrene/acrylic copolymers, styrene/maleic anhydride copolymers, isobutylene/maleic anhydride copolymers, vinyl acetate/ethylene copolymers, ethylene/acrylic acid copolymers, polyolefins, polystyrenes, olefin and styrene copolymers, epoxy resins, acrylic latex polymers, rubbers, natural rubbers, butyl rubbers, nitrile rubbers, polyester acrylate oligomers and polymers, polyester diol diacrylate polymers, UV-curable resins, polyamides, etc.

Suspensions containing polymerizable monomers and/or oligomers may also be used, wherein at least a portion of the polymer binder is formed by polymerizing the monomers and/or oligomers in the presence of the graphene sheets. In such cases the monomers and/or oligomers can serve as some or all of the solvent.

Suitable decomposition heating temperatures are at least about 150° C. The film may also be heated at least about 200° C., at least about 300° C., at least about 400° C., at least about 500° C., at least about 750° C., at least about 1000° C., at least about 1100° C., at least about 1200° C., at least about 1300° C., at least about 1500° C., at least about 2000° C., at least about 2200° C., between about 300 and 750° C., between about 300 and 1000° C., between about 750 and 1500° C., and between about 950 and about 2000° C. Higher heating temperatures often lead to tapes with increased electrical conductivity and decreased mechanical properties.

Heating may be done in any suitable vessel (including furnaces) and preferably under a non-oxidizing atmosphere such as nitrogen or argon.

The tapes may be further annealed by heating after the binder is decomposed. At temperatures above about 1500° C., healing of certain graphene lattice defects may occur.

The films may be peeled off the substrate prior to the binder decomposition step or after the tapes have been formed.

In some embodiments, the films and tapes may have a thickness of about 0.1 micron to about 1 micron, or about 0.1 microns to about 1 mm, or about 1 micron to about 1 mm, or about 1 micron to about 500 microns, or about 5 microns to about 500 microns, or about 10 microns to about 100 microns, or about 20 microns to about 75 microns, or about 30 microns to about 60 microns. Thicker films may be formed by coating one or more additional layers over an already formed film or tape.

The tapes are preferably free-standing, self-supporting materials that may be handled unattached to a substrate or other backing materials. Free-standing tapes may be attached to other materials, including surface, substrates, backing materials, etc. when used in certain applications.

There are no particular limitations to the length and width of the tapes. They may be cut or otherwise formed into any desired shape. They may be sufficiently flexible to be bent at an angle of at least about 90° without breaking. In some cases they may be sufficiently flexible to bent at an angle of at least about 150° without breaking. The radius of curvature may be less than about 1 cm.

The tapes can have a density of about 0.05 to about 1 g/cm³, or about 0.1 to about 0.6 g/cm³. The tapes can have a surface area of at least about 30 m²/g, or at least about 50 m²/g, or at least about 100 m²/g, or at least about 150 m²/g, or at least about 200 m²/g, or at least about 300 m²/g, or at least about 400 m²/g, or at least about 500 m²/g, or at least about 700 m²/g. Surface area can be measured as described above using either the nitrogen adsorption/BET method at 77 K or a methylene blue (MB) dye method in liquid solution.

The tapes can have carbon to oxygen ratios in the same ranges as those described above for the graphene sheets.

The tapes can in some cases have conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m.

In some embodiments, the tapes may have tensile strengths of about 1 to about 30 MPa, or about 5 to about 30 MPa, or about 10 to about 30 MPa. In some embodiments, the tapes may have Young's modulus of about 0.1 to about 20 GPa, or about 0.5 to about 15 GPa, or about 0.5 to about 10 GPa, or about 1 to about 10 GPa.

The tapes can be used for a variety of applications, such as energy storage devices, electrodes and counter electrode for electrochemical devices such as ultracapacitors, supercapacitors, batteries (including lithium batteries such as lithium ion batteries), sensors, sensor arrays, etc. They can be used a conductive coatings, such as, for example, electromagnetic shielding or charge dissipation. They can be used as shielding materials, catalysts, and high surface area conductive catalyst scaffolds. They can be used as supports for catalysts in fuel cells.

The tapes may be used as electrodes in solar cells, including dye-sensitized solar cells (DSSC). They may be used as counter electrodes (such as catalytic counter electrodes), including in dye-sensitized solar cells.

The electrodes may be incorporated into DSSCs using any suitable method, including using a thermomelt sealant such as Surlyn®, or Bynel® by DuPont, or being coated directly on the hole conducting material. The electrode can be used with any appropriate and compatible hole conductor system, such as an electrolyte system with a redox couples (such as iodide/triiodide, Co^{II/III}(dbbip)₂](ClO4)₂ (e.g. Co^{II} and Co^{III} complexes), (SeCn)⁻₃/SeCN⁻, all with or without gelators), solid-state hole conductor materials (such as spiro-OMeTAD (2,2′,7,7′-tetrakis(N,N-di-p-methoxypheny-amine)-9,9′-spirobi-fluorene), ionic liquids, or molten salts.

In some embodiments, the cells may have a power conversion efficiency of at least about 3%, or at least about 4%, or at least about 5%, or at least about 6%, or at least about 10%.

### EXAMPLES

### Electrical Conductivity Measurements

Electrical conductivity measurements were made similarly to the described ISO3915 standard procedure. Copper tapes (3M, 3M Center, St. Paul, Minn. 55144, USA) were attached to the two sides of a rectangular piece of graphene tape or compressed graphene pellet and a constant current of 2-10 mA was applied using a potentiostat (SP-150, BioLogic, P.O. Box 30009, Knoxville Tenn. 37930, USA). For compressed pellets, carbon paste (Electron Microscopy Sciences, 1560 Industry Rd., Box 550 Hatfield, Pa. 19440, USA) was applied between the sample and the copper tape in order to ensure equipotential cross sectional areas. Potential difference between two points along the direction of the current flow was simultaneously recorded for 20 s using the same potentiostat. The average potential drop and the applied current were used to calculate the conductivity of the samples using the formula:

$$σ = \frac{I}{V} \cdot \frac{l}{A} ,$$

where I, V, l and A are the applied current, measured potential difference, distance between the two points where the potential difference is measured, and the cross sectional area for the current flow, respectively.

### Mechanical Testing

Mechanical testing was done using a load frame (Instron model 5567A, Instron, 825 University Ave., Norwood, Mass. 02062, USA) equipped with pneumatic grips with rubber faces. Dogbone-shaped samples were cut from composite tapes using a punch of the appropriate shape and size. Samples were 4.55 mm wide and 22.55 mm long. Following thermolysis, the reduced and the annealed samples were tested under tensile load applied at a velocity of 1 mm/min.

### Examples 1-3 and Comparative Examples 1-3

### General Procedure for the Preparation of Graphene Tapes

The fabrication of graphene tapes began by production of graphene/surfactant/organic binder films, which were cast from a suspension of graphene sheets stabilized with a poly(ethylene oxide)-poly(propylene oxide)-poly(ethylene oxide) (EO₁₀₆PO₇₀EO₁₀₆) triblock copolymer surfactant (F-127, Pluronic®, Sigma-Aldrich, 3050 Spruce Street, St. Louis, Mo. 63103, USA) in an aqueous poly(ethylene oxide) (PEO, Mᵥ 600,000; Sigma-Aldrich) binder solution. To produce the graphene suspensions, an EO₁₀₆PO₇₀EO₁₀₆ surfactant solution was prepared in deionized water. The surfactant was present in the same amount by weight as the amount of graphene sheets to be added. Graphene sheets (Vor-x™, Vorbeck Materials Inc., 8306 Patuxent Range Road, Jessup, Md. 20794, USA) were added to the solution over about 1 h with stirring, ultrasonication, and cooling. The resulting suspension was then centrifuged at 900 g for 10 min to remove any remaining agglomerates and the supernatant was decanted. These refined suspensions were then transferred to a vacuum chamber and stirred under slight vacuum to remove entrained air.

Binder solutions of 4.5 wt. % PEO were prepared by first adding the PEO powder to absolute ethanol (Acros, Janssen-Pharmaceuticalaan 3a, Geel 2440, Belgium) with stirring at 65° C. and then adding an equal volume of water. Pre-mixing with ethanol prevents the formation of clumps and facilitates the homogeneous dispersion of the PEO. Stock PEO solutions were then added to the graphene/surfactant suspensions to obtain graphene/surfactant/PEO tape casting suspensions of desired weight ratios. The tape casting suspensions were stirred for at least 2 h prior to casting. The percentages of graphene relative to the combined amount of graphene, binder, and surfactant are given in Tables 1 and 2.

The glass plates on which the tapes were cast were prepared by first cleaning their surfaces using detergent followed by 1 M KOH (aq) solution (Acros). After rinsing and drying, the surfaces were treated with a mixed silane solution (a mixture of 6.6 mM octadecyltrichlorosilane (Sigma-Aldrich) and 3.3 mM aminopropyltriethoxy silane (Sigma-Aldrich) in hexane (Acros) then dried to reduce the adhesion between the glass and the composite tape. Without this silane treatment, the tapes could not be peeled cleanly off the glass.

The graphene/surfactant/PEO suspensions were cast on the silane coated glass plate using a doctor blade assembly (Model SDBA, Richard E. Mistier, Inc., Morrisville, Pa. 19076, USA) with a 1.5 mm blade gap in a class 1,000 soft wall clean room (Model DFE1214-7, Atmos-Tech Industries, 1108 Pollock Ave., Ocean, N.J. 07712, USA). The tapes were dried in the clean room at ambient temperature for several days and then removed from the glass templates to obtain large, free standing composite films.

The thermolysis of the binder and surfactant from these composite films to form the tapes was done in a graphite-element furnace (Model 1000, Thermal Technology LLC, 1911 Airport Blvd., Santa Rosa, Calif. 95403, USA). In order to heat many samples in each batch, composite films were stacked alternating with Grafoil® sheets (GTB grade, 5 mil thick, Union Carbide, P.O. Box 94637, Cleveland, Ohio 44101, USA). The pressure in the furnace chamber was first reduced to 100 mTorr and then backfilled with dry nitrogen to atmospheric pressure in order to decompose the organics in a non-oxidizing atmosphere. Thermolysis runs were done under flowing nitrogen at 2 SCFM (3.4 m³/h). In the case of the tapes of Example 1, the furnace chamber was heated to 90° C. at 5° C./min, held for 1 h to remove volatiles, then heated to 315° C. at 5° C./min and held at the higher temperature for 10 h. The tapes of Example 2 were made in the same way, except that they were heated for another 1 h at 1000° C. The tapes of Example 3 were made in the same way as those of Example 1, but were heated for another 1 h at 2250° C.

When higher temperatures were used for subsequent processing, the furnace temperature was raised at 10° C./min to the target temperature. As decomposition of nitrogen becomes appreciable above 1237° C., for heat treatments above 1000° C. argon was used in the furnace chamber as the inert atmosphere.

The results of conductivity and mechanical testing are given in Tables 1 and 2 (averages of several measurements and their standard deviations (s.d.) are reported.

### Comparative Example

### Graphene Pellets

Graphene pellets, comprised only of compacted graphene sheets, were made by compressing about 100-150 mg of graphene sheets using a cylindrical stainless steel die with inner diameter of 2.9 cm and height of 4.4 cm under a hydraulic press (Carver Laboratory Press, Model-C, Fred. S. Carver Inc., W142 N9050 Fountain Blvd., Menemonee Falls, Wis. 53051, USA. The density of the pellets was adjusted by varying the load between 40 and 150 MPa. Subsequent heat treatments for the pellets were done under the same conditions used for the thermolysis of the composite films to make the graphene tapes described above. Comparative Example 1 used the same heating conditions as Example 1, Comparative Example 2 used the same conditions as Example 2, and Comparative Example 3 used the same conditions as Example 3. The volume percentage graphene in the pellets (relative to the amount of graphene and free pore space) was estimated based on the density of the pellets.

The electrical conductivities of the pellets were measured and the results are given in Table 3. It was not possible to measure the mechanical properties of the pellets as they were too fragile; they would crumble when subjected to all but the mildest of handling.

TABLE 1

| | | | Conductivity | |
|---|---|---|---|---|
| | Wt % | Density | (S/m) | |
| | graphene | (g/cm³) | avg. | s.d. |
| Ex. 1 | 12 | 0.13 | 131 | 19 |
| | 15 | 0.15 | 226 | 26 |
| | 20 | 0.17 | 299 | 36 |
| | 25 | 0.23 | 473 | 72 |
| | 30 | 0.28 | 721 | 138 |
| | 40 | 0.40 | 1439 | 162 |
| Ex. 2 | 15 | 0.12 | 2230 | 371 |
| | 20 | 0.17 | 3116 | 999 |
| | 25 | 0.21 | 4762 | 519 |
| | 30 | 0.26 | 6761 | 444 |
| | 40 | 0.40 | 11191 | 1167 |
| Ex. 3 | 15 | 0.19 | 7103 | 1934 |
| | 20 | 0.29 | 13297 | 2566 |
| | 25 | 0.32 | 13652 | 2573 |
| | 30 | 0.36 | 19062 | 3916 |
| | 35 | 0.41 | 17467 | 4123 |
| | 40 | 0.51 | 24033 | 3369 |

TABLE 2

| | | Modulus | | Strength | | Elongation | |
|---|---|---|---|---|---|---|---|
| | Wt % | (MPa) | | (MPa) | | (%) | |
| | graphene | avg. | s.d. | avg. | s.d. | avg. | s.d. |
| Ex. 1 | 20 | 514 | 242 | 1.4 | 1.2 | 0.3 | 0.2 |
| | 25 | 556 | 261 | 0.8 | 0.6 | 0.2 | 0.1 |
| | 30 | 2463 | 2329 | 2.0 | 1.7 | 0.3 | 0.2 |
| | 40 | 2075 | 626 | 6.2 | 2.0 | 0.7 | 0.7 |
| Ex. 2 | 15 | 2942 | 1477 | 8.5 | 5.4 | 0.5 | 0.2 |
| | 20 | 776 | 264 | 3.1 | 2.0 | 0.5 | 0.2 |
| | 25 | 1343 | 329 | 5.3 | 3.8 | 0.7 | 0.2 |
| | 30 | 2040 | 647 | 8.1 | 4.1 | 0.5 | 0.2 |
| | 40 | 3149 | 649 | 16.9 | 7.7 | 0.7 | 0.1 |
| Ex. 3 | 15 | 540 | 57.5 | 2.3 | 1.0 | 0.5 | 0.2 |
| | 20 | 1047 | 127 | 5.6 | 0.9 | 0.7 | 0.1 |
| | 25 | 1800 | 207 | 7.5 | 3.5 | 0.6 | 0.3 |
| | 30 | 2149 | 500 | 7.9 | 5.6 | 0.5 | 0.3 |
| | 35 | 2802 | 710 | 11.4 | 6.6 | 0.8 | 0.8 |
| | 40 | 3215 | 964 | 9.8 | 5.4 | 0.4 | 0.1 |

TABLE 3

| | Vol. % | Conductivity |
|---|---|---|
| | graphene | (S/m) |
| Comp. Ex. 1 | 13 | 667 |
| | 18 | 1073 |
| | 21 | 1287 |
| | 24 | 1359 |
| Comp. Ex. 2 | 14 | 841 |
| | 17 | 1369 |
| | 21 | 1676 |
| Comp. Ex. 3 | 7 | 3272 |
| | 12 | 5957 |
| | 14 | 9209 |
| | 17 | 12510 |

### Examples 4-6 and Comparative Example 4

### Graphene Tapes as Electrodes for Solar Cells

### Preparation of Counter Electrodes

For electrodes used in electrochemical impedance spectroscopy (EIS) and DSSCs, graphene counter electrodes were prepared on FTO (TEC8 Hartford Glass). A Graphene-(F-127) suspension (1.66 wt % graphene, 1.66 wt % F-127 in water) was mixed in a PEO solution (0.6 g in 10 mL water, 10 mL ethanol) in a 1:4 graphene:PEO weight ratio and stirred overnight. The resulting suspension was spin coated onto clean FTO (fluorine-doped tin oxide) substrates at speeds of 1000, 2000, and 4000 rpm (corresponding to those used in Examples 4, 5, and 6, respectively) for 4 min. The resulting film was dried at room temperature and then the surfactants were thermally decomposed in an ashing furnace at 350° C. in air for 2 h. Thermally treated chloroplatinic acid electrodes, (used for Comparative Example 4), were prepared as described in the Journal of The Electrochemical Society 1997, 144, (3), 876-884. Briefly, 2 μL of 5 mM chloroplatinic acid in isopropanol were drop cast on an FTO electrode with a 0.39 cm² mask. The sample was then heated to 380° C. for 20 min before use.

### Preparation of DSSCs

DSSCs were constructed as described previously in the literature (Journal of the American Chemical Society 1993, 115, (14), 6382-6390) In brief, 2 g of P25 titania nanoparticles (Evanonik) were suspended with 66 μL of acetylacetone and 3.333 mL deionized water. Titania films, four layers thick, were cast on TiCl₄ treated FTO glass using a scotch tape mask and a glass rod via the doctor blade technique. These films were then heated to 485° C. for 30 min in air before being placed in a 0.2M TiCl₄ solution for 12 h and heated to 450° C. for 30 min. The resulting electrode was immersed in a 0.3 mM N3 dye—ethanol (Acros) solution for 20 h to form the sensitized photocathode. Platinum and graphene counter electrodes were formed as described above. A 25 μm Surlyn film (Solaronix) was used to separate the photocathode and counter electrode and seal the cell after electrolyte (Iodolyte AN-50 from Solaronix) was added. Cells were tested immediately after fabrication.

### Measurements

Current-voltage characteristics of DSSCs were taken under AM1.5G light, simulated at 100 mW/cm² with a 16S solar simulator (SolarLight) using a potentiostat (Biologic SP-150) to apply various loads. Data values presented are the average of 2 to 6 identically prepared samples. The results are given in Table 4, where V_{oc} refers to the open circuit voltage. J_{sc} refers to the short circuit current density. η refers to cell efficiency (the cell's maximum power output divided by the input power, per area). FF refers to the fill factor, which is the ratio of the maximum power obtainable in the device to the theoretical maximum power [FF=(J*×V*)/(J_{sc}×V_{oc}), where J* and V* are the current density and voltage, respectively, at the cell's maximum power output].

EIS was performed on the electrodes using a Biologic SP-150 potentiostat. EIS was performed using a sandwich cell configuration with symmetric tape electrodes (Example 4) and symmetric platinum coated FTO electrodes (Comparative Example 4) in an acetonitrile electrolyte containing 0.5 M Lil and 0.05 M I₂. A 25 μm thick Surlyn® film was used to separate the tape electrodes and seal the cells. EIS measurements were taken from 0 V to 0.8 V, the magnitude of the alternating signal was 10 mV, and the frequency range was 1 Hz to 400 kHz. ZFit (Biologic), with the appropriate equivalent circuit, in which the mid-frequency hump from about 2500 to about 25 Hz represents the charge transfer resistance (R_{CT}), was used to analyze the impendence spectra and determine R_{CT} of the electrodes. The results are given in Table 5.

TABLE 4

| | Electrode | | | | |
|---|---|---|---|---|---|
| | material | V_{oc} (V) | J_{sc} (mA cm⁻² ) | FF | η (%) |
| Example 4 | Graphene | 0.64 | 13.16 | 0.60 | 4.99 |
| | tape | | | | |
| Comparative | Platinum | 0.64 | 13.03 | 0.67 | 5.48 |
| Example 4 | on FTO | | | | |

TABLE 5

| | Coating spin | R_{CT} value (Ohm cm²) | | |
|---|---|---|---|---|
| | rate (rpm) | 0 V Bias | 0.3 V Bias | 0.5 V Bias |
| Example 4 | 1000 | 9.37 | 1.82 | 1.19 |
| Example 5 | 2000 | 14.49 | 1.96 | 1.18 |
| Example 6 | 3000 | 19.70 | 2.77 | 1.45 |
| Comparative | not applicable | 0.82 | 0.8 | 0.79 |
| Example 4 | | | | |

1. A graphene tape.

2. The tape of claim 1, wherein the tape is free-standing.

3. The tape of claim 1, having a surface area of at least about 200 m²/g.

4. The tape of claim 1, having a surface area of at least about 400 m²/g.

5. The tape of claim 1, having an electrical conductivity of at least about 100 S/m.

6. The tape of claim 1, having an electrical conductivity of at least about 1000 S/m.

7. The tape of claim 1, having an electrical conductivity of at least about 20,000 S/m.

8. A method of forming a graphene tape, comprising the steps of forming a film comprising graphene sheets and at least one polymer binder and heating the film to decompose the binder.

9. The method of claim 8, wherein the film is formed from a suspension comprising graphene sheets, at least one binder, and at least one solvent.

10. The method of claim 8, wherein the graphene sheets are covalently bound to each other prior to and/or after heating.

11. The method of claim 8, wherein the binder is one or more from poly(ethylene oxide), poly(propylene oxide), and poly(ethylene oxide)/poly(propylene oxide) copolymers.

12. The method of claim 8, wherein the suspension further comprises at least one surfactant.

13. The method of claim 8, wherein the solvent comprises water.

14. The method of claim 8, wherein the film is formed on a substrate.

15. The method of claim 8, wherein the film is removed from the substrate prior to heating the film.

16. The method of claim 8, wherein the film is heated to at least 300° C.

17. The method of claim 8, wherein the film is heated to at least 1000° C.

18. The method of claim 8, wherein the graphene sheets have a carbon to oxygen molar ratio of at least about 15:1.

19. The tape of claim 1 in the form of an electrode.

20. A battery comprising the electrode of claim 19.
